(19) United States
(12) Patent Application Publication
(10) Pub. No.: US 2025/0083767 A1
(43) Pub. Date: Mar. 13, 2025

(54) REVERSIBLE CONTOURED PEDALS

(71) Applicant: IntoWorld LLC DBA Bike Different, Red Wing, MN (US)

(72) Inventor: Christopher Lucas, Red Wing, MN (US)

(73) Assignee: IntoWorld LLC DBA Bike Different, Red Wing, MN (US)

(21) Appl. No.: 18/828,314

(22) Filed: Sep. 9, 2024

Related U.S. Application Data
(60) Provisional application No. 63/537,375, filed on Sep. 8, 2023.

(51) Int. Cl. B62M 3/08

(52) U.S. Cl. CPC B62M 3/086

(57) ABSTRACT

A pedal block may have an elongated quasi-cuboid structure characterized by a first foot-contacting surface on one face having a first front end and a first back end, and a second foot-contacting surface on an opposite face having a second front end and a second back end. A pedal spindle may be disposed in the pedal block between the first foot-contacting surface and the second foot-contacting surface and may include an axle and a crank attachment. The first foot-contacting surface and the second foot-contacting surface may each be contoured to contact a substantial portion of a foot of a rider whose foot is disposed on either the first foot-contacting surface or the second foot-contacting surface. A heel cup may be provided to support the heel and ankle of the rider.

### CROSS-REFERENCE TO RELATED APPLICATIONS

This application claims priority to U.S. Provisional Application Ser. No. 63/537,375, titled “Reversible Contoured Pedals,” filed Sep. 8, 2023. This application incorporates the entire contents of the foregoing application herein by reference.

### TECHNICAL FIELD

Various implementations relate generally to pedals for a bicycle, tricycle, or other human-powered vehicle with one or more wheels.

### BRIEF DESCRIPTION OF THE DRAWINGS

FIG. 1A is a perspective view of an exemplary pedal conversion kit for a bicycle.

FIG. 1B depicts how a pedal from the pedal conversion kit of FIG. 1A may be attached to a bicycle crank arm.

FIGS. 2A-2E illustrate details of an exemplary pedal block.

FIGS. 3A-3F illustrate details of exemplary straps.

FIGS. 4A-4D illustrate details of other exemplary straps and heel cups.

FIGS. 5A-5B illustrate additional exemplary pedals and straps.

### DETAILED DESCRIPTION

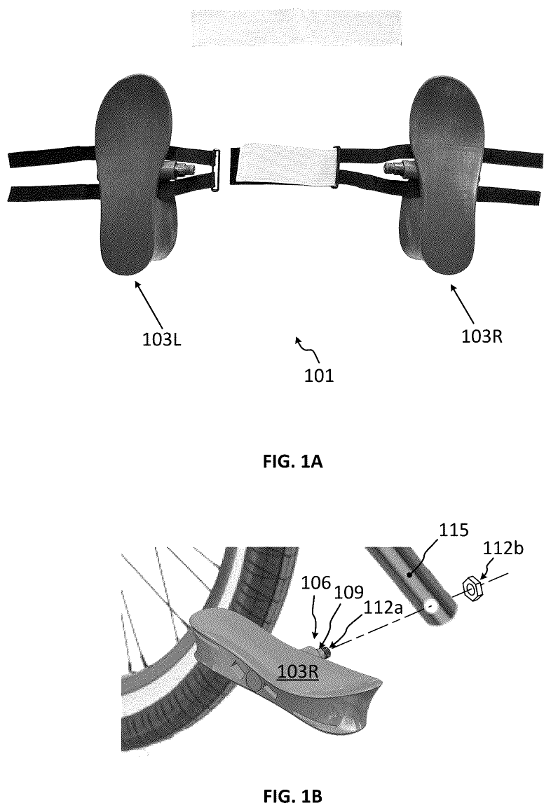

FIG. 1A is a perspective view of an exemplary pedal conversion kit 101 that may be employed with a bicycle or other foot-powered vehicle (e.g., tricycle, unicycle, recumbent bicycle, e-bike, etc.). In some implementations, as shown, the conversion kit includes a first pedal block 103L and second pedal block 103R. Each of the first pedal block 103L and the second pedal block 103R may be reversible (e.g., both sides may be employed as a foot-contacting surface), and each side may be contoured in such a manner as to make substantial contact with a rider's foot. In some implementations, the contour is configured to conform to a rider's bare foot, when such a bare foot is disposed on the pedal; in some implementations, the contour is configured to make substantial contact with a rider's shoe. (In this context, “substantial contact” may mean contact over at least 25%, 50% or 75% of the surface area of a bottom of the rider's bare foot.)

Turning to FIG. 1B, each of the pedal blocks (e.g., pedal block 103R) has a spindle 106 having an axle 109 and a crank attachment 112 that is configured to be fixedly coupled to a bicycle crank arm 115. In some implementations, as shown, the crank attachment 112 may include a bolt portion 112a and a nut portion 112b. The kit may be provided such that riders of a foot-powered vehicle can swap out original equipment pedals with reversible, contoured pedals that may facilitate more comfortable and secure riding for a rider who has bare feet or feet only covered with form-fitting footwear (e.g., socks, water shoes, etc.).

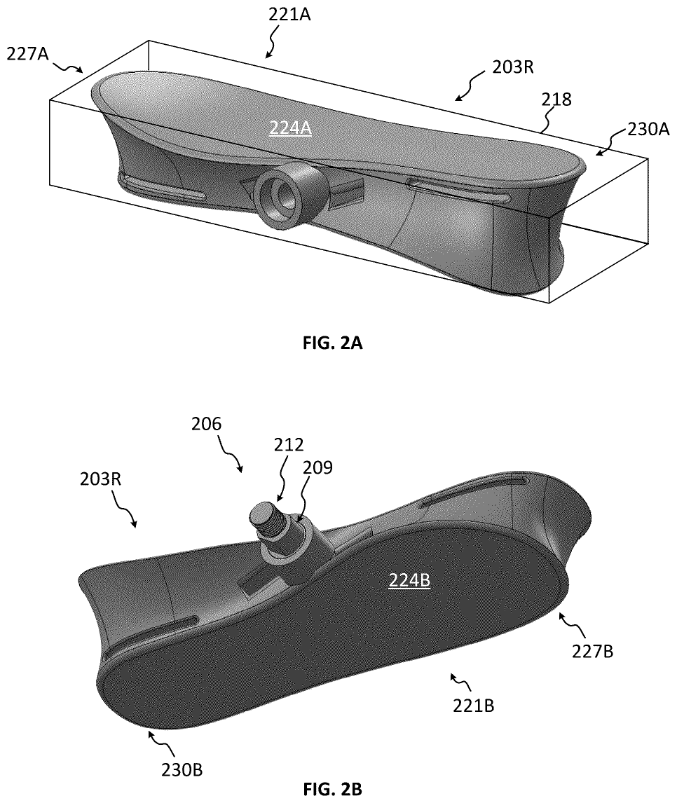

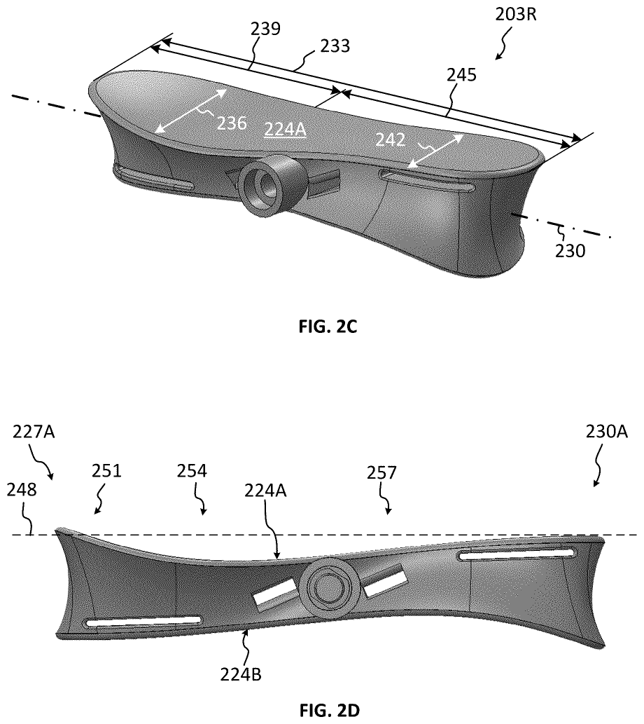

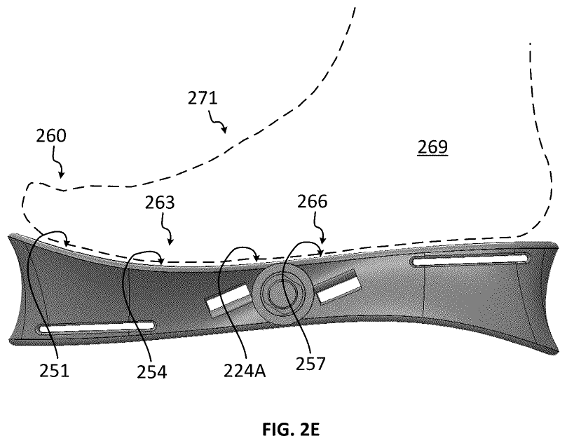

FIG. 2A illustrates additional detail of an exemplary pedal block 203R. As shown, the pedal block 203R may take the general form of an elongated quasi-cuboid structure 218—elongated in the sense that the cuboid structure is stretched in one or more dimensions, and quasi-cuboid in the sense that edges are curved and contoured relative to a true cuboid, but nevertheless in the general shape of an elongated cuboid. With this form as a reference, the exemplary pedal block 203R has a first face 221A and a second face 221B (see FIG. 2B, which shows the exemplary pedal block 203R rotated to show the second face 221B), which may include, respectively, a first foot-contacting surface 224A and a second foot-contacting surface 224B. As used herein, “foot-contacting surface” refers to a surface that is configured to contact either a shoe of a rider or the rider's bare foot.

The first foot-contacting surface 224A includes a first front end 227A and a first back end 230A; and the second foot-contacting surface 224B includes a second front end 227B and a second back end 230B. In some implementations, as shown, the first foot-contacting surface 224A is disposed opposite the second foot-contacting surface 224B, such that the first front end 227A is disposed opposite the second back end 230B, and the first back end 230A is disposed opposite the second front end 227B.

A pedal spindle 206 may be disposed in the pedal block 203R between the first foot-contacting surface 224A and the second foot-contacting surface 224B, substantially parallel to the width. As described with reference to the implementation shown in FIG. 1B, the pedal spindle 206 may include an axle 209 and a crank attachment 212 and be configured such that, when the crank attachment 212 is fixedly coupled to a bicycle crank arm, the pedal block 203R can freely rotate about the pedal spindle 206 (e.g., facilitated by bearings (not shown) inside the pedal spindle 206).

Turning to FIG. 2C, the pedal block 203R may be characterized by a longitudinal axis 230, a length 233 whose extent substantially parallels the longitudinal axis 230, and a width whose extent is substantially perpendicular to the longitudinal axis 230. (In this context, “substantially parallels” may mean parallels within about 5°, 10°, 15°, 25°, 30°, etc.; and “is substantially perpendicular to” may mean within about 85°, 80°, 75°, 65°, 60°, etc.).

In some implementations, as shown, a width may be more precisely characterized by an average front width 236, corresponding to a front half 239 of the first foot-contacting surface 224A; and an average back width 242, corresponding to a back half 245 of the first foot-contacting surface 224A. (In this context, “half” may mean about 50% of the length, where “about” may mean within 1%, 5%, 10% or 25% of a nominal value; thus, “front half” may refer to the front about 38% to about 63% of the length.) In some implementations, the average front width 236 is greater than the average back width 242.

In some implementations, as shown in FIG. 2D, each of the first foot-contacting surface 224A and the second foot-contacting surface 224B is contoured to contact a substantial portion of a bare foot of a rider whose foot is disposed on either the first foot-contacting surface 224A or the second foot-contacting surface 224B. That is, in some implementations, the first foot-contacting surface 224A is contoured, relative to a planar surface 248, to have—moving from the first front end 227A to the first back end 230A—a rise 251, a dip 254 and an arch support 257. As depicted in FIG. 2E; the rise 251, the dip 254 and the arch support 257 may be configured to correspond to toes 260, metatarsals 263 and arch 266 of a bare foot 269 of a rider, when the bare foot 269 is disposed on the first foot-contacting surface 224A. In other implementations, each of the first foot-contacting surface and the second foot-contacting surface is contoured to contact a substantial portion of the shoe of a rider. Contours of the first foot-contacting surface and the second foot-contacting surface may be such that natural curvature of a rider's shoed feet are supported and engaged during pedaling.

In some implementations, the first foot-contacting surface 224A and the second foot-contacting surface 224B have matching surface contours. In other implementations, the first foot-contacting surface 224A and the second foot-contacting surface 224B have different surface contours. For example, the first foot-contacting surface 224A may provide relatively greater arch support and the second foot-contacting surface 224B may provide relatively lesser arch support—such that a rider could choose one of the foot-contacting surfaces 224A or 224B that best matches his or her foot anatomy. As another example, a first foot-contacting surface may be configured to facilitate bare foot riding, and the second foot-contacting surface may be flatter or differently curved or contoured to facilitate shoed riding.

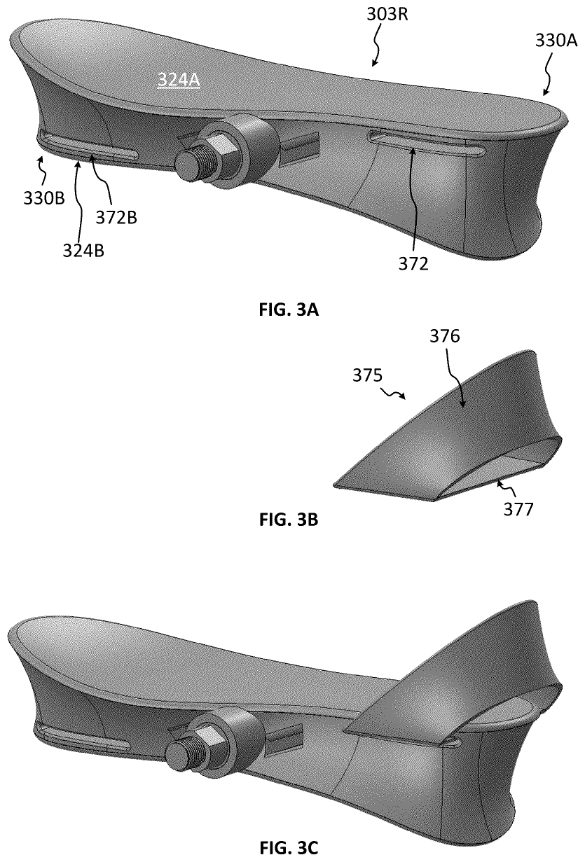

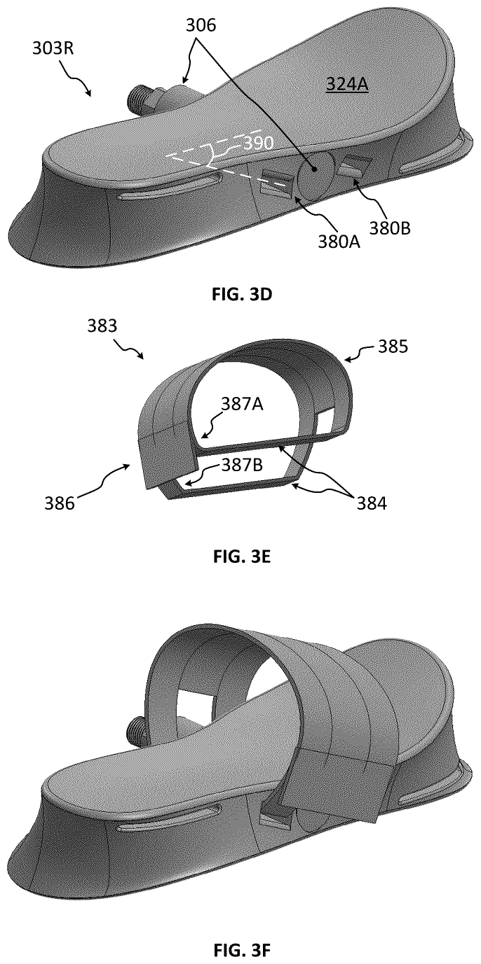

Turning to FIG. 3A, an exemplary pedal block 303R may include an ankle-strap aperture 372 adjacent a first foot-contacting surface 324A, near a first back end 330A. The ankle-strap aperture 372 may be configured to accommodate an ankle strap 375 (see FIG. 3B) that has an anchor portion 377 that is configured to be disposed in the ankle-strap aperture 372 and an ankle support portion 376 that is configured to contact and support an ankle of a rider whose foot is disposed on the first foot-contacting surface 324A. FIG. 3C illustrates how the ankle strap 375 may be disposed in the ankle-strap aperture 372, in some implementations.

In some implementations, the ankle strap 375 comprises webbing having a first end and a second end (not shown) and complementary fastener components (not shown) that facilitate threading the ankle strap through the ankle-strap aperture and coupling the first end to the second end with the complementary fastener components. The complementary fastener components may include a hook portion and a loop portion of a hook-and-loop fastening system. The pedal block 303R may include a supplemental ankle-strap aperture 372B adjacent the second foot-contacting surface 324B, near the second back end 330B.

In some implementations, as illustrated in FIGS. 3D-3F, the pedal block 303R further includes one or more arch-strap apertures 380A and 380B adjacent the spindle 306. The one or more arch-strap apertures 380A and 380B may be configured to receive an arch strap 383 having an anchor portion 384, which is configured to be disposed in the one or more arch-strap apertures 380A and 380B, and a foot-retention portion 385 that is configured to adjustably hold a midfoot portion (e.g., portion 271, shown in FIG. 2E) of a rider's foot—when such a rider's foot is disposed on the first foot-contacting surface 324A—against the first foot-contacting surface 324A.

In some implementations, the arch strap 383 comprises webbing having a first end 386 and a second end (e.g., collectively, 387A and 387B) and complementary fastener components (not shown) that facilitate threading the arch strap through the one or more arch-strap apertures 380A and 380B and coupling the first end to the second end with the complementary fastener components. As shown, the one or more arch-strap apertures 380A and 380B may include a first arch-strap aperture 380A and a second arch-strap aperture 380B, and the anchor portion 384 may include a first end 386 and a second end that includes two tabs, 387A and 387B, that are configured to be coupled to the first end 386 with a fastening system (e.g., a hook-and-loop fastening system).

In some implementations, the first arch-strap aperture 380A is disposed on one side of the spindle 306 and the second arch-strap aperture 380B is disposed on an opposite side of the spindle 306. The arch-strap apertures 380A and 380B may be disposed at an angle 390 relative to a plane that is substantially parallel to the first foot-contacting surface 324—such as, for example, an angle that is between 10° and 45°; or more preferably, between about 20° and 30°;or even more preferably at about 25°. (In general, “about” or “approximately” may mean within 1%, or 5%, or 10%, or 20% or 50% of a nominal value.)

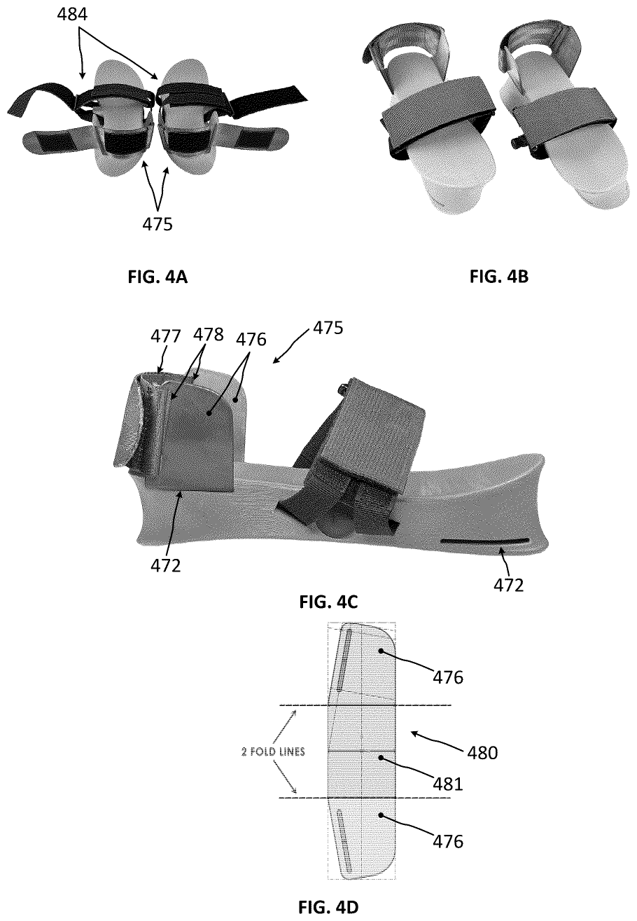

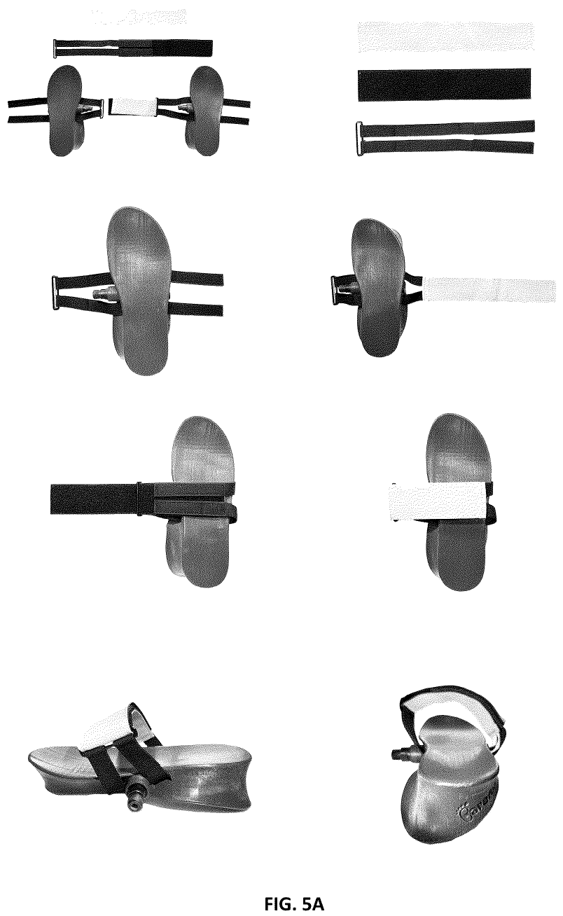

FIGS. 4A-4C illustrate alternative implementations having a different design for arch straps 484 and including heel cups 475 in place of the ankle straps 375 shown in FIGS. 3B-3C. As shown, the heel cups 475 may include stirrup fins 476 that are retained by a heel-cup aperture 472. As shown, a heel strap 477 may be threaded through apertures 478 in the stirrup fins 476 and may be adjustably secured with hook-and-loop or other fasteners—so as to support a rider's heel and ankle.

In some implementations, the stirrup fins 476 are formed from a single piece of material, such as a polycarbonate (or other polymer or metal) sheet 480 (see FIG. 4D), which may be formed into a middle portion 481, and two upturned stirrup fins 476. Collectively, the middle portion 481 and the stirrup fins 476 may be referred to as the stirrup assembly. In some implementations, forming may include employing thermoforming and use of a brake to bend the stirrup fins 476 away from the middle portion 481. In some implementations, the stirrup fins 476 may be disposed vertically relative to the middle portion 481; and in other implementations, the stirrup fins 476 may be disposed at an angle off vertical (e.g., 10° off vertical, or 80° or 100° relative to the middle portion 478; 15° off vertical, or 75° or 105° relative to the middle portion; etc.).

Heel cups 475 may provide more secure support to a rider's heel and ankle than other implementations. That is, such a design may minimize slippage of the rider's feet from pedals and may minimize injury that can occur on so-called “tadpole” trikes (or other low-to-the-ground recumbent bicycles) when a rider's foot slips of the pedal and the rider's corresponding foot or leg become caught under a crossbar of the tricycle or bicycle.

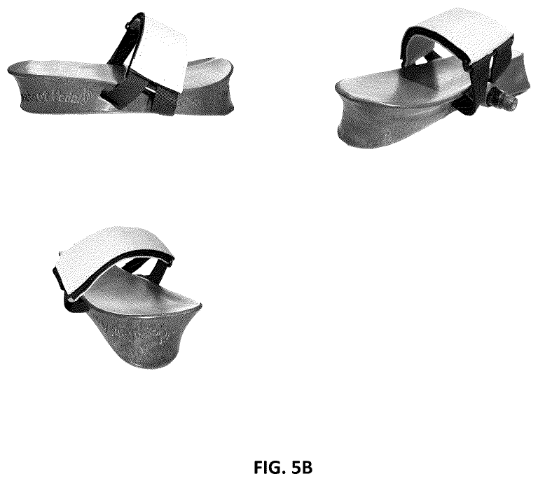

FIGS. 5A-5B illustrate additional implementations and details of exemplary pedal blocks and arch straps. Some implementations include foot-shaped bicycle pedals that conform to the soles of cyclists' feet. Some implementations are so comfortable, cyclists can regularly ride in their bare feet. Candidate riders may include commuters and recreational cyclists who want more comfort and performance when pedaling bicycles. Implementations may also be employed by cyclists who ride in street shoes, soft-soled shoes like sneakers or tennis shoes, flip-flops, sandals or socks.

Implementations can be manufactured in many ways, including, for example, a 3D-printing process called direct laser melting (DLM), whereby fine layers of aluminum alloy powder are progressively melted by laser. To reduce weight, a low-percentage lattice structure infill may be employed. Other 3D-printing processes may be employed, such as fused deposition modeling (FDM), where very thin layers of molten plastic filament are extruded onto a heated build platform. Acrylonitrile styrene acrylate (ASA) may be used in some implementations—a polymer similar to ABS. Layer height may be 200 microns (0.2 mm), and infill density may be 20%. In 3D-printed implementations, a modeling program may be used to dimension specific pedals. Left and right pedals may essentially be mirrored images of each other (with the exception of any logos or other indicia). Materials may be weatherproof, UV-resistant and fade-resistant in sunlight.

Higher volume implementations may be molded. For example, a 3D-printed cast may be produced using stereolithography (SLA), which, in some implementations, may offer a smoother surface with few or no layer lines, relative to other 3D-printing methods. A silicone mold may then be created by pouring liquid silicone that solidifies into a flexible mold around the SLA cast. The SLA cast may be removed from the mold, and a foaming epoxy resin may be injected into the silicone mold cavity, forming a smooth, hard, impact resistant shell around lightweight expanded foam core. Such a silicone mold may then be used many times to create pedals; and when the silicone mold wears out, it may be remade from the original SLA cast for additional production runs.

Straps may take various forms. For example, a strap may include one cinch strap threaded through a slot in the pedal block underneath the pedal surface, through a plastic or metal buckle on the crank side of the pedal, drawn across the foot metatarsal/arch and fastened to itself with a hook-and-loop strip to secure a cyclist's foot onto the pedal. In other implementations, each arch strap (or heel strap) may include two pieces of fabric made from polyester or nylon webbing, seatbelt webbing, animal leather, vegan leather (e.g., cork strips laminated to polyester microfiber fabric), or other similar materials, with sewn-in hook-and-loop fasteners, and a plastic or metal buckle. A lower fabric piece may have separate straps that are threaded through two slots on both sides fore and aft of the pedal axle, then threaded through a plastic or metal buckle, then wrapped around and attached to a second upper strap with hook-and-loop fasteners. An upper strap may also be threaded through the buckle and doubled over itself and the first strap to form an adjustable strap over the arch/metatarsal part of the foot.

In some implementations, ankle straps may be made from three separate pieces of polyester or nylon webbing that are cut and sewn together at various angles, threaded through a wide ankle-strap slot (e.g., 50 mm wide) beneath the cyclist's heel, and fastened together with hook-and-loop fasteners underneath the heel to form a “heel cup” or “ankle cup” (“heel” and “ankle” may be used interchangeably here, as the angle of contact—and thus the specific anatomical part contacting the cup or strap—may depend on the position the cyclist's foot relative to the pedal) enclosure that wraps around and supports a portion of the cyclist's foot, thereby helping to keep the cyclist's foot in position on the pedal surface.

Some implementations include three parts—the pedal platform; the pedal axle, or spindle as it may be called; and either or both of an “arch strap” or a “heel strap.” Multiple slots may be employed to retain arch straps, and the slots may be angled off horizontal (e.g., at about 24°, in some implementations) on the fore and aft sides of the axle, allowing the arch strap to be centered more precisely over the metatarsal arch section of the cyclist's feet. A third slot beneath and parallel with the heel surface of the pedal may be provided for a heel strap.

In some implementations, pedal axles are comprised of lightweight chrome-molybdenum alloy, steel or titanium alloy axle spindles, along with a set of two loose or sealed ball bearings on the inside and outside ends of the axles. Other materials may be employed. Axle spindles and bearings may be inserted into an axle hole and secured with a bearing cup, a race or cone nut, a keyed washer, and a lock nut on the outside of the hole to provide smooth pedal rotation. To install pedals described herein, existing pedals may be removed. Then, the new pedals may be screwed into the crank arm of a bicycle.

Pedals may be shaped like an average human foot, and the surface may be contoured to conform to the curvature of the sole of an average human foot. A slight upward curvature on the end of the pedal surface may provide additional pedaling leverage. Alternatively, pedals may be sized and shaped to engage shoes (that is, pedals may be contoured to substantially engage the width and length of common shoe sizes (e.g., about size 10 for men or about size 9 for women)). In some implementations, pedals as described herein provide more efficient pedaling performance with continuous contact along the entire foot-to-pedal interface or shoe-to-pedal interface—more evenly distributing pedaling forces over a larger, smoother foot-shaped pedal surface area under the entire foot sole, centered over the pedal axles, in line with the direction of force coming through cyclists' legs and feet onto the pedals.

Pedals may be two-sided and reversible, with rotational symmetry. In some

implementations, this may give cyclists the option of pedaling with straps on one side of the pedal for longer distance cycling (providing more power on the upstroke), then flipping the pedals over to pedal “strapless” (allowing the cyclist to put their feet down on the ground quickly when cycling through stop-and-go traffic on city streets).

Kits may be provided that give cyclists the option of either (or both) adjustable arch cinch straps, or heel straps that can be attached on either side of the pedals to hold cyclists' feet securely and comfortably on the pedals. Arch straps may be designed for cyclists riding on conventional road bikes with upright handlebars, beach cruisers, city commuter bikes, “fixies,” crank-forward bikes, or long wheelbase recumbent bicycles with lower cranksets. Arch cinch straps with hook-and-loop fasteners may allow cyclists to adjust the tightness of the strap to fit securely over the metatarsal arch of the cyclist's feet, for a comfortable, snug fit around their feet, to hold cyclists' feet securely on the pedals.

Pedals equipped with heel straps or heel cups as described herein may be safer than other pedals for cyclists riding on short wheelbase recumbent bicycles and tricycles, as short wheelbase recumbent bikes and trikes often have their cranks in front of the front wheel, rather than behind the front wheel. On short wheelbase recumbent bikes and trikes, cranksets may be higher, and cyclists' legs may be positioned in a nearly horizontal position. When cyclists' feet are in this position, feet could otherwise (absent the heel strap or heel cup) slide backward off the back end of the pedals while the cyclist is cycling. Pedals with heel straps as described herein may help keep short wheelbase recumbent cyclists' feet from slipping backwards off the pedals.

Implementations may be more comfortable than conventional square, cleated, studded “bear trap” or “spiky brick”-style pedals. Unlike many other pedals, pedals described herein may allow cyclists' feet to “float”, or rotate laterally from side-to-side while riding and may assist in aligning feet with twisting legs, thereby minimizing strain on the knees, in some implementations.

Implementations may be customizable in various sizes, shapes or colors. Some implementations may be custom-made to conform precisely to cyclists' feet. For example, an app may be provided to enable a cyclist to scan his or her feet, then upload models into a modeling/production process. As another example, different sizes may be available to correspond to different men's and women's shoe sizes (e.g., sizes 5, 6, 7, 8, 9, 10, 11, 12, for either men or women).

Several implementations have been described with reference to exemplary aspects, but it will be understood by those skilled in the art that various changes may be made and equivalents may be substituted for elements thereof without departing from the contemplated scope. Many other variations are possible, and modifications may be made to adapt a particular situation or material to the teachings provided herein without departing from the essential scope thereof. Therefore, it is intended that the scope include all aspects falling within the scope of the appended claims.

What is claimed is:

1. A bicycle pedal comprising:
a pedal block having an elongated quasi-cuboid structure characterized by (i) a first foot-contacting surface on one face having a first front end and a first back end, (ii) a second foot-contacting surface on an opposite face having a second front end and a second back end; and (iii) a longitudinal axis, a length whose extent substantially parallels the longitudinal axis, and a width whose extent is substantially perpendicular to the longitudinal axis; and
a pedal spindle disposed in the pedal block between the first foot-contacting surface and the second foot-contacting surface, substantially parallel to the width; the pedal spindle comprising an axle and a crank attachment and being configured such that, when the crank attachment is fixedly coupled to a bicycle crank arm, the pedal block can freely rotate about the pedal spindle;
wherein the first foot-contacting surface and the second foot-contacting surface are each contoured to contact a substantial portion of a foot of a rider whose foot is disposed on either the first foot-contacting surface or the second foot-contacting surface.

2. The bicycle pedal of claim 1, wherein the first foot-contacting surface is contoured, relative to a planar surface, to have, moving from the first front end to the first back end, a rise, a dip and an arch support; the rise, the dip and the arch support configured to correspond, respectively, to toes, metatarsals and arch of the foot.

3. The bicycle pedal of claim 1, wherein a front half of the first foot-contacting surface is characterized by an average front width, a back half of the first foot-contacting surface is characterized by an average back width, and the average front width is greater than the average back width.

4. The bicycle pedal of claim 1, wherein the first foot-contacting surface and the second foot-contacting surface have matching surface contours.

5. The bicycle pedal of claim 1, wherein the first foot-contacting surface and the second foot-contacting surface have different surface contours.

6. The bicycle pedal of claim 1, wherein the first front end is disposed opposite the second back end, and the first back end is disposed opposite the second front end.

7. The bicycle pedal of claim 1, wherein the pedal block further comprises a heel-cup aperture adjacent the first foot-contacting surface, near the first back end.

8. The bicycle pedal of claim 7, further comprising a heel cup having a middle portion that is configured to be disposed in the heel cup aperture and stirrup fins that extend upward from the middle portion and include apertures that receive an adjustable heel strap.

9. The bicycle pedal of claim 8, wherein the heel strap comprises webbing having a first end, a second end and complementary fastener components that facilitate threading the heel strap through the apertures in the stirrup fins and coupling the first end to the second end with the complementary fastener components.

10. The bicycle pedal of claim 8, wherein the stirrup fins are disposed at an angle off vertical, relative to the middle portion, wherein the angle is about 10 degrees.

11. The bicycle pedal of claim 7, wherein the pedal block further comprises a supplemental heel-cup aperture adjacent the second foot-contacting surface, near the second back end.

12. The bicycle pedal of claim 1, wherein the pedal block further comprises one or more arch-strap apertures adjacent to the spindle.

13. The bicycle pedal of claim 12, further comprising an arch strap having an anchor portion that is configured to be disposed in the one or more arch-strap apertures and a foot-retention portion that is configured to adjustably hold a midfoot portion of a rider's foot—when such a rider's foot is disposed on the first foot-contacting surface—against the first foot-contacting surface.

14. The bicycle pedal of claim 13, wherein the arch strap comprises webbing having a first end, a second end and complementary fastener components that facilitate threading the arch strap through the one or more arch-strap apertures and coupling the first end to the second end with the complementary fastener components.

15. The bicycle pedal of claim 13, wherein the one or more arch-strap apertures comprise a first arch-strap aperture and a second arch-strap aperture, and wherein the anchor portion comprises a first end and a second end, the first end comprising two tabs and the second end comprising two corresponding tabs, the tabs and corresponding tabs configured to be coupled to each other with a fastening system.

16. The bicycle pedal of claim 15, wherein the first arch-strap aperture is disposed on one side of the spindle and the second arch-strap aperture is disposed on an opposite side of the spindle.

17. The bicycle pedal of claim 12, wherein the one or more arch-strap apertures are disposed at an angle relative to a plane that is substantially parallel to the first foot-contacting surface and the second foot-contacting surface.

18. A pedal conversion kit comprising:
a first pedal block and a second pedal block; wherein each of the first pedal block and second pedal block has (i) an elongated quasi-cuboid structure characterized by (A) a first foot-contacting surface on one face having a first front end and a first back end, (B) a second foot-contacting surface on an opposite face having a second front end and a second back end; (C) a longitudinal axis, a length whose extent substantially parallels the longitudinal axis, and a width whose extent is substantially perpendicular to the longitudinal axis; (ii) a pedal spindle disposed between the first foot-contacting surface and the second foot-contacting surface, substantially parallel to the width; (iii) a heel-cup aperture adjacent the first foot-contacting surface, near the first back end; and (iv) one or more arch-strap apertures adjacent the spindle;
a first heel cup and a second heel cup, each of the first heel cup and the second heel cup comprising a stirrup assembly having a middle portion that is configured to be disposed in the heel-cup aperture, and stirrup fins on either side of the middle portion, each with apertures that receive an adjustable heel strap that is configured to contact and support a heel and ankle of a rider whose foot is disposed on the first foot-contacting surface; and
a first arch strap and a second arch strap, each of the first arch strap and the second arch strap having an arch-strap anchor portion that is configured to be disposed in the one or more arch-strap apertures, and a foot-retention portion that is configured to adjustably hold a midfoot portion of a rider's foot-when such a rider's foot is disposed on the first foot-contacting surface-against the first foot-contacting surface.
